(19) United States
(12) Patent Application Publication
(10) Pub. No.: US 2007/0119160 A1
(43) Pub. Date: May 31, 2007

(54) UNITIZED HYDRAULIC SYSTEM

(75) Inventor: Peter C. Menze, Marquette, MI (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Ludington Technologies, Inc., Escanaba, MI (US)

(21) Appl. No.: 11/559,835

(22) Filed: Nov. 14, 2006

Related U.S. Application Data
(60) Provisional application No. 60/736,218, filed on Nov. 14, 2005.

(51) Int. Cl. F16D 31/02

(52) U.S. Cl. 60/431

(57) ABSTRACT

A unitized hydraulic system comprises a tank for holding hydraulic fluid, a hydraulic pump powered by a pump motor for receiving hydraulic fluid from the tank and creating a high pressure stream of fluid, a control valve for receiving hydraulic fluid from the hydraulic pump and regulating movement of the hydraulic fluid within the system, an actuator for receiving hydraulic fluid from the control valve to drive a shaft coupled to the actuator, and a controller in communication with the pump motor and configured to provide controlled actuation of the pump motor, wherein all components are coupled together to form a single unit which is capable of being easily installed and interchanged.

### CROSS REFERENCE TO RELATED APPLICATIONS

This application claims the benefit of U.S. Provisional Patent Application Ser. No. 60/736,218, filed Nov. 14, 2005, the entirety of which is incorporated by reference.

### BACKGROUND OF THE INVENTION

Generally speaking, the present invention relates to hydraulic systems. More specifically, the present invention relates to a unitized hydraulic system which can be used as a single component of another device or system.

Hydraulic systems are widely used for a number of applications in today's society. Most of these hydraulic systems are utilized in different mechanical devices, which are used for many different applications. For example, manufacturing equipment typically uses hydraulic systems to operate certain manufacturing processes. Further, construction and earth moving equipment (bulldozers, front end loaders, graders, etc.) all utilize hydraulic systems to actuate and move various components. As another example, snowplows typically utilize hydraulic cylinders to move and position plowing blades. Similarly, lawn care devices, especially more complex mowers and turf care equipment, also utilize hydraulic devices for various purposes. Naturally, this is a short list of examples, and several other applications exist.

As can be appreciated, hydraulic systems range in complexity from very straightforward simple systems, to very complex. On the more simple side, a single hydraulic cylinder or hydraulic actuator of some type may be used. Conversely, more complex systems such as the above-mentioned earth moving equipment involves multiple cylinders and multiple control components, all cooperating with one another to allow multiple components to be moved and positioned in desired ways. In each of these systems, hydraulic components, mechanical components, and electrical components are all combined to create a system which achieves the desired results.

As mentioned above, a typical hydraulic system will include multiple components. For example, a typical hydraulic system will likely contain a reservoir for maintaining fluid utilized in the system. Naturally, hydraulic actuators are required to achieve the desired movements and positioning. In order to move fluid and create pressures necessary within the hydraulic cylinders, pumps are required, along with fluid handling components such as hoses and related couplings. To direct fluid movement, a valve system must be incorporated which allows fluid to be moved in appropriate directions and at appropriate pressures. Naturally, electrical components are typically coupled with many of these different devices to control overall operation. These electrical components may include actuator switches and control devices utilized by the operator, and may also include multiple sensors and control devices (e.g. controllers) to achieve desired operation.

As suggested above, necessary coupling and attachment devices are often utilized in hydraulic system applications. For example, hoses will typically carry hydraulic fluid from the reservoir tank to an actuator or switching mechanism of some type. When the switches or actuators are actually utilized, additional hoses are required to carry the necessary fluid from the actuator to the actual hydraulic cylinder. Additionally, return hoses or reversing hoses are often required to achieve desired operations. As can be imagined, the use of these multiple hoses, along with all related fittings and coupling components, is not entirely desirable and increases the complexity of the system.

In addition to the hydraulic components mentioned above, corresponding electrical couplings and controls are often included, thus increasing the complexity of the system.

In each application, it is desirable to reduce the complexity of a system as much as possible. Due to the various concerns, however, this is often not possible or realistic.

### BRIEF SUMMARY OF THE INVENTION

The present invention solves the foregoing problems by providing a unitized hydraulic system including a tank for holding hydraulic fluid, a hydraulic pump powered by a pump motor for receiving hydraulic fluid from the tank and creating a high pressure stream of fluid, a control valve for receiving hydraulic fluid from the hydraulic pump and regulating movement of the hydraulic fluid within the system, an actuator for receiving hydraulic fluid from the control valve to drive a shaft coupled to the actuator, and a controller in communication with the pump motor and configured to provide controlled actuation of the pump motor. Each of these components is coupled to one another to create a single component.

As mentioned above, the present invention combines the necessary components to create a unitized system which has several advantages. Specifically, a single utilized system can be installed and utilized within a piece of equipment, as a single component. Further, the single hydraulic actuator, for performing some defined movement, can be designed into a system, without the overall need for coordinating components typically utilized. As a result, individual unitized hydraulic systems can easily be replaced and swapped, by simply removing the entire component and replacing as necessary.

One approach to creating the unitized system is through the use of a single housing which is designed to contain the necessary components. Specifically, a fluid holding tank is designed within the housing, along with appropriate fluid flow pathways. Additionally, the housing is designed to contain a hydraulic pump, powered by an appropriate motor, which is also in fluid communication with the tank and necessary fluid pathways. Also, the necessary valves are incorporated within the housing to move fluid in a predetermined manner. The hydraulic cylinder of the present invention includes an actuator and a related shaft which is designed to move consistent with a typical hydraulic cylinder. In this case, the hydraulic cylinder, actuator and related shaft are all designed to be an integral components of the overall system.

In its anticipated application, the unitized hydraulic system will simply include necessary physical connections to allow for attachment to the physical devices contemplated, along with appropriate electrical connections to provide power and control signals. The power supply will be attached to the appropriate connector to provide power to drive the pump motor, thus generating the necessary hydraulic pressure utilized by the system. Additionally, electrical control signals are also provided to the system to control actual movement of the actuator itself.

Again, the contemplated application includes attachment of the unitized hydraulic system to a framework of some type, and to an actuated component. Consequently, when the actuator is moved through its typical stroke, the related component is likewise moved. Due to the unitized nature of the system of the present invention, the entire system is capable of easy replacement where necessary. Consequently, should replacement be necessary, the unitized system can simply be disconnected from its physical connections, and electrical connections, and simply replaced with an identical system.

In addition to the replacement advantages outlined above, system designers are also provided with a simplified tool to achieve the functions necessary. Rather than concern themselves with placement of hoses and fluid lines, along with appropriate electrical couplings, system designers can simply purchase the unitized system of the present invention for incorporation into their equipment. Consequently, the only design criteria for the equipment designer are the physical attachment mechanisms, and electrical control connections (in addition to providing enough space and clearance). All other concerns related to fluid handling pumps, and other components (e.g., valves and sensing components) are simply included in the design of the unitized hydraulic system.

As generally outlined above, it is an object of the present invention to provide a single hydraulic system which is virtually self-contained and capable of using incorporation into related equipment. Consequently, the equipment designer and maintenance personal have greatly simplified responsibilities and tasks and can concern themselves with other aspects of the equipment design.

It is a further object of the present invention to provide a hydraulic actuator system which is easily incorporated into an equipment design, and likewise easily repaired should any conditions exist.

Further objects and advantages of the present invention can be seen by reading the following detailed description in conjunction with the accompanying drawings.

### BRIEF DESCRIPTION OF THE DRAWINGS

FIG. 1 is a perspective view of one embodiment of a unitized hydraulic system according to the present invention

FIG. 2A is a side view of the unitized hydraulic system of FIG. 1 with a shaft in a retracted position.

FIG. 2B is a side view of the unitized hydraulic system of FIG. 1 with the shaft in an extended position.

FIG. 3 is a diagram illustrating a hydraulic system having a first unitized hydraulic system, a second unitized hydraulic system, a third unitized hydraulic system, and multiplexing means for delivering signals to the hydraulic systems.

FIG. 4A is a diagram illustrating a pair of unitized hydraulic systems according to the present invention coupled to and configured to control position of a snowplow blade.

FIG. 4B is a diagram illustrating the snowplow blade in a V-shaped configuration.

FIG. 5 is a perspective view of a second embodiment of the unitized hydraulic system.

FIG. 6 is a front view of the unitized hydraulic system shown in FIG. 5.

FIG. 7 is a cross sectional view of the unitized hydraulic system shown in FIG. 6 with the cross section taken along E-E.

FIG. 8 is a side view of the unitized hydraulic system shown in FIG. 5.

FIG. 9 is a side view of an additional embodiment of the present invention incorporating an auxiliary fluid tank.

### DETAILED DESCRIPTION OF THE INVENTION

The present invention involves a unitized hydraulic system for use in multiple applications. As will be further described below, by combining multiple unitized hydraulic systems, many different device applications could be achieved. Each unitized hydraulic system may be entirely self-contained and may include, among other components, a motor, control electronics, a hydraulic pump, a hydraulic control valve, and a hydraulic cylinder. Furthermore, all fluid flow paths may be entirely self-contained within the unitized system, thus eliminating the need for hoses and complex valve bodies. Generally speaking, control of the unitized system may be achieved via electrical controls which actuate the motor in an appropriate way.

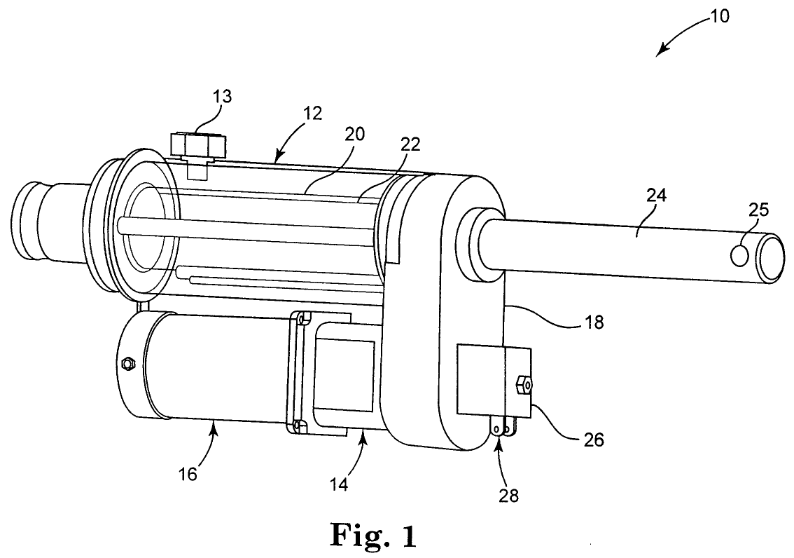

FIG. 1 is a perspective view of one embodiment of a unitized hydraulic system 10 according to the present invention, which includes tank 12, hydraulic pump 14, pump motor 16, control valve 18, and an actuator including hydraulic cylinder 20. In FIG. 1, the outer walls of tank 12 and cylinder 20 are transparent to provide a view into cylinder 20, and to illustrate cooperating components. In the preferred embodiments, these components are typically not transparent. Hydraulic cylinder 20 includes piston 22 disposed within the cylinder. Coupled to piston 22 is shaft 24 which, as will be described in more detail to follow, moves axially with piston 22 as the volume of high pressure hydraulic fluid within hydraulic cylinder 20 is varied.

As can be seen in FIG. 1, all components of unitized hydraulic system 10 are integrated into a self-contained unit. Specifically, shown in the upper portion of FIG. 1 is fluid tank 12. Fluid tank 12 is designed to hold fluid, such as hydraulic fluid or oil that is circulated throughout unitized hydraulic system 10. Fluid tank includes removable cap 13, which allows a user to either add or remove hydraulic fluid from tank 12 as necessary. Although not visible in FIG. 1, appropriate fluid handling passages are incorporated into the design of fluid tank 12 so as to allow appropriate fluid movement throughout unitized hydraulic system 10. In the embodiment of FIG. 1, fluid tank 12 is shown surrounding cylinder 20. It will be understood that fluid tanks which do not surround a cylinder, and are located at various other locations, are also contemplated. In addition, a reserve fluid tank may also be incorporated into unitized hydraulic system 10 to ensure a sufficient amount of hydraulic fluid is always available.

Hydraulic pump 14 is coupled to fluid tank 12 in such a way to allow hydraulic fluid to be received from fluid tank 12. Within hydraulic pump 14, all necessary components are included to create a necessary stream of high pressure hydraulic fluid. The stream of high pressure hydraulic fluid may then be distributed to cylinder 20 to control axial movement of piston 22. Many different types of hydraulic pumps may be incorporated into unitized hydraulic system 10 including, but not limited to, gear pumps, vane pumps, or axial pumps.

As can be appreciated, care must be taken to insure that fluid can flow to pump 14 in a controlled manner. Naturally, tank 12 will have an outlet, which is designed to allow fluid to flow to pump 12. In the tank design of the present invention, the outlet of the tank is specifically design to take into consideration any operating peculiarities that may be encountered. For example, when the hydraulic cylinder is to be operated in a horizontal orientation, tank 12 is designed to have its fluid outlet in a portion of the tank that will be positioned on a “bottom” side thereof. Thus, gravity flow of fluid will ensure that pump 14 will draw fluid when needed, and not be pulling air into the hydraulic system. Similar care must be taken when tank 12 will be operated in a vertical orientation. In some instances, it is possible for a single inlet location to meet both of these needs. In other cases, the system must be modified slightly to meet the particular operating conditions.

It is further contemplated that the unitized hydraulic system of the present invention may include a unique inlet design that is configured to move as needed. For example, where tank 12 and cylinder 20 are required to move through a particular travel path which causes fluid within the tank to be shifted, the tank may include a slidable inlet which moves as needed to insure fluid is provided to pump 14. In this manner, the unitized hydraulic system will be capable of operation regardless of its orientation. Such a movable inlet may be attached to an internal hose, or may include a slidable coupling that is attached to the housing.

Pump motor 16 is coupled to hydraulic pump 14 to operate and drive the pump in a desired manner. In particular, pump motor 16 provides power to hydraulic pump 14, which then uses that energy to create the stream of high pressure hydraulic fluid. Pump motor 16 is typically an electric motor or engine and may be connected to hydraulic pump 14 through, for example, gears, belts, or a flexible elastomeric coupling.

Control valve 18 is functionally disposed between hydraulic pump 14 and hydraulic cylinder 20. In particular, control valve 18 is in fluid connection with hydraulic pump 14 and routes hydraulic fluid to the desired location within unitized hydraulic system 10. In one embodiment, control valve 18 may consist of a spool inside a housing, wherein the spool slides to different positions within the housing. Hydraulic fluid is then routed to the desired location based upon the position of the spool within the housing. Naturally, other valve configurations are possible.

Hydraulic cylinder 20 is located in the upper portion of unitized hydraulic system 10 and is in fluid connection with control valve 18. Hydraulic cylinder 20 is configured to receive controlled amounts of fluid from control valve 18 to control the axial position of piston 22 within the cylinder. In particular, hydraulic cylinder 20 includes a fluid port on each end of the cylinder to admit or return hydraulic fluid. Because shaft 24 is coupled to piston 22, movement of piston 22 drives axial movement of shaft 24. For instance, control valve 18 may route the high pressure stream of hydraulic fluid to a first portion of hydraulic cylinder 20, thereby causing shaft 24 to extend. On the other hand, control valve 18 may route the high pressure stream of hydraulic fluid to a second portion of hydraulic cylinder 20, thereby causing shaft 24 to retract.

Shaft 24 is designed such that it may be coupled to a component to control (at least in part) movement of that component. For example, as shown in FIG. 1, shaft 24 includes through-hole 25 which is configured to receive a pin or similar element to secure shaft 24 to another component. In one embodiment of shaft 24, the shaft may have a 2 inch diameter and a 10 inch stroke. However, one skilled in the art would appreciate that the shaft diameter and stroke required will depend upon the particular application of unitized hydraulic system 10, and that shafts having any diameter or stroke are contemplated and within the scope of the present invention.

Although a specific attachment coupling is not shown, it is understood that the cylinder, or some portion of the cylinder, would also be attached to other components. For example, in many equipment applications, the cylinder is attached to a framework of some type, while the shaft 15 attached to a movable component. As one example, in a snowplow application, the cylinder may be attached to a vehicle while the shaft would be attached to the plow blade to achieve the lifting function.

As can be seen in FIG. 1, unitized hydraulic system 10 may also include controller 26. Controller 26 may be configured to receive and send signals to operate one or more of the components within unitized hydraulic system 10. For instance, in reference to pump motor 16, controller 26 may send a signal to pump motor 16 indicating the timing and the magnitude of the power the pump motor should supply to hydraulic pump 14. In reference to control valve 18, controller 26 may send a signal to control valve 18 indicating the desired route of hydraulic fluid through the control valve.

Unitized hydraulic system 10 may include an electrical connection means such as electrical connector 28 on controller 26. Electrical connector 28 may be designed to provide power to any component of unitized hydraulic system 10 requiring power to operate. For example, electrical connector 28 may serve as the means to connect electrical power to pump motor 16. Although electrical connector 28 is shown as a standard two-prong plug, other types and configurations of electrical connectors are contemplated.

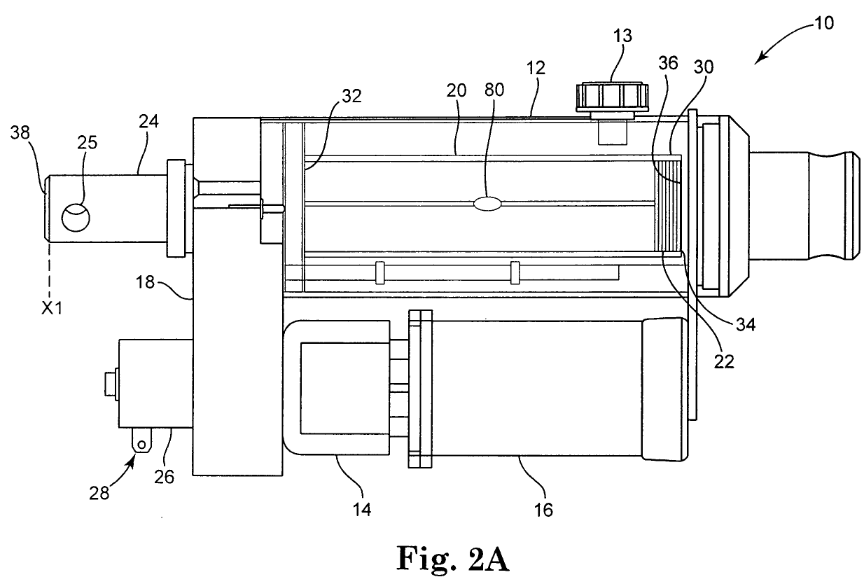

FIGS. 2A and 2B illustrate the axial range of motion of shaft 24, which is driven by hydraulic cylinder 20 as described above in reference to FIG. 1. In particular, FIG. 2A is a side view of unitized hydraulic system 10 with shaft 24 in a retracted position. As shown in FIG. 2A, hydraulic cylinder 20 has first side 30 and second side 32. Similarly, piston 22 has first side 34 and second side 36. When the hydraulic fluid within hydraulic cylinder 20 is controlled such that first side 34 of piston 22 contacts first side 30 of hydraulic cylinder 20, shaft 24 is in the fully retracted position. In the retracted position, end portion 38 of shaft 24 extends to a location X1 outside of hydraulic cylinder 20.

FIG. 2B is a side view of unitized hydraulic system 10 with shaft 24 in an extended position. When the hydraulic fluid within hydraulic cylinder 20 is controlled such that second side 36 of piston 22 contacts second side 32 of hydraulic cylinder 20, shaft 24 is in the fully extended position. In the extended position, end portion 38 of shaft 24 extends to a location X2 outside of hydraulic cylinder 22. Thus, as indicated in FIG. 2B, the axial range of motion of shaft 24 may be represented by ΔX. One skilled in the art would understand that although only the fully retracted and fully extended shaft positions are illustrated in FIGS. 2A and 2B, pump 14 and control valve 18 may control the hydraulic fluid within hydraulic cylinder 20 such that end portion 38 of shaft 24 may be positioned anywhere between locations X1 and X2.

As can be seen in FIGS. 2A and 2B, unitized hydraulic system 10 may also include a sensor S coupled to hydraulic cylinder 20. In particular, sensor S may be designed to sense speed of piston 22 as it moves through hydraulic cylinder 20, axial position of piston 22 within hydraulic cylinder 20, or both. In some applications of the present invention, the speed at which piston 22 (and thus, shaft 24) moves may be important. For example, extending or retracting shaft 24 at a rapid rate may create safety concerns for users or the potential of damaging the device to which the hydraulic system is attached. In addition, in some applications of the present invention, it may be helpful to monitor the position of piston 22 within hydraulic cylinder 20. Because shaft 24 is attached to piston 22, there is a known relationship between the location of end portion 38 of shaft 24 and piston 22. Therefore, by determining the position of piston 22 with respect to hydraulic cylinder 20, the position of end portion 28 of shaft 24 may also be determined. The position sensor may be useful to sense when piston 22 reaches a position within cylinder 20 that corresponds with the desired position of end portion 38 of shaft 24.

Controller 26 may be coupled to sensor 80 to allow the controller to receive signals related to the speed and/or position of piston 22 to control operation of cylinder 20. Thus, sensor 80 may be useful for providing “real-time” feedback to control the operation of shaft 24. In addition, controlled, accurate presets for position and/or speed may be pre-programmed into controller 26 to enable automated positioning of shaft 24.

Although unitized hydraulic system 10 is described as having an actuator comprising a hydraulic cylinder, other types or actuators including but not limited to rotary actuators and motors may be used without departing from the intended scope of the present invention. Furthermore, although the components of unitized hydraulic system 10 are shown and described in reference to particular locations with the system, one skilled in the art would understand that the location of one or more of the components within the self-contained system may be varied without departing from the intended scope of the present invention.

In a first alternative embodiment of the unitized hydraulic system shown in FIG. 1, hydraulic pump 14 may be a bi-directional hydraulic pump, thereby eliminating the need for control valve 18 to control the axial position of piston 22 within cylinder 20. A typical bi-directional hydraulic pump could include two outlet ports, with one of the outlet ports feeding the first portion of hydraulic cylinder 20, and the other outlet port feeding the second portion of hydraulic cylinder 20. A switching means internal to the pump would allow control of the outlet ports such that only one outlet port may distribute hydraulic fluid at any point in time. In effect, when the hydraulic pump feeds the first portion of hydraulic cylinder 20, shaft 24 may move to the extended position. Similarly, when the hydraulic pump feeds the second portion of hydraulic cylinder 20, shaft 24 may move to the retracted position. Thus, as would be appreciated by one skilled in the art, a bidirectional pump may eliminate the need for control valve 18 to route hydraulic fluid to the desired portion of hydraulic cylinder 20.

In addition to controlling the axial range of motion of shaft 24, pump motor 16 may also help control the speed that shaft 24 moves within hydraulic cylinder 20. For example, in reference to the first alternative embodiment described above having a bi-directional hydraulic pump, pump motor 16 may be a switched reluctance motor configured to provide power to the bidirectional hydraulic pump. In general, a switched reluctance motor is a rotating electric machine having a stator and rotor with salient poles. The motor is excited by applying a sequence of current pulses at each phase, such as by pulse width modulation. One advantage of a switched reluctance motor, as compared to a permanent magnet motor, is its ability to operate over a wide speed range at constant power. Controlling the speed of pump motor 16 enables control over the pressurization of hydraulic fluid within the hydraulic pump. As a result, the speed of piston 22 (and thus, shaft 24) within hydraulic cylinder 20 may be controlled.

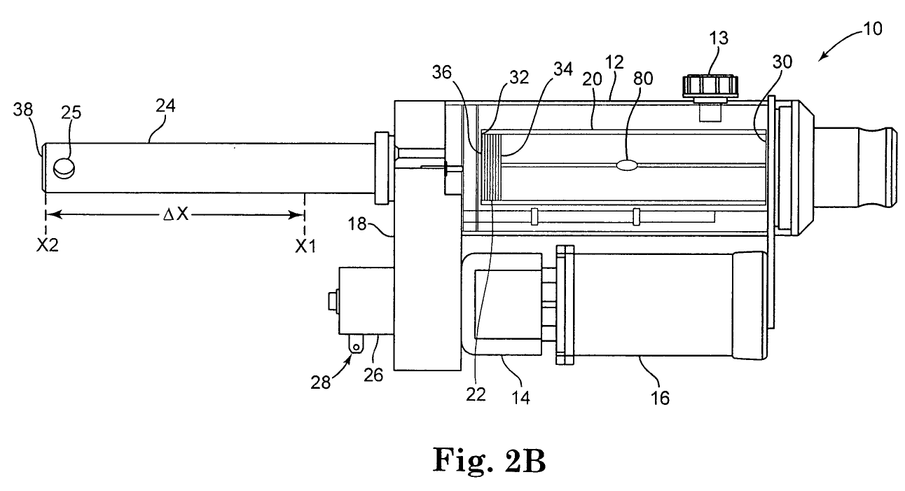

FIG. 3 is a diagram illustrating a hydraulic system 40 having a first unitized hydraulic system 110, a second unitized hydraulic system 210, and a third unitized hydraulic system 310. Although FIG. 3 depicts three unitized hydraulic systems, a hydraulic system incorporating any number of unitized hydraulic systems is possible and within the intended scope of the present invention.

When multiple unitized hydraulic systems are coupled to form a larger hydraulic system, coordinated control of the various hydraulic systems is required. This coordinated control may be achieved by using well understood multiplexing and sensing concepts to control each hydraulic system.

In general, multiplexing involves sending multiple signals or streams of information on a carrier at the same time in the form of a single, complex signal and then recovering the separate signals at the receiving end. In reference to FIG. 3, hydraulic system 40 further comprises multiplexing means 42 for providing coordinated control of unitized hydraulic systems 110, 210, and 310. Multiplexing means 42 includes signal input device 44, carrier line 46, first multiplexed node 48, second multiplexed node 50, and third multiplexed node 52.

Signal input device 44 of multiplexing means 42 is configured to control and provide instructions (signals) to unitized hydraulic systems 110, 210, and 310. In one embodiment, a user manually inputs instructions into signal input device 44 as necessary to achieve the desired function of hydraulic system 40. In another embodiment, signal input device 44 may receive signals from sensors (such as those described above in reference to FIGS. 2A and 2B) and provide instructions to unitized hydraulic systems 110, 210, and 310 based upon those signals. In yet another embodiment, instructions may be pre-programmed into signal input device 44, which may then be delivered to unitized hydraulic systems 110, 210, and 310 at specified times or upon the occurrence of specified events.

Signal input device 44 provides a signal to unitized hydraulic systems 110, 210, and 310 over carrier line 46. First multiplexed node 48, second multiplexed node 50, and third multiplexed node 52 then extract any portion of the multiplexed signal pertaining to their associated unitized hydraulic system. Thus, signal input device 44 combines multiple signals into a single data stream, while multiplexed nodes 48, 50, and 52 split the single data stream into the original, multiple signals for use by the unitized systems.

Similar to the discussion above, speed and position of the shafts within the unitized hydraulic systems may be controlled by using speed sensors and position sensors, as well as by pulse width modulation. Also, to differentiate the various hydraulic systems making up an overall system, it is contemplated that electrical control may key the various systems to their position and function within the overall system. Consequently, ease of interchangeability is achieved. Furthermore, frequency hopping could be used in conjunction with multiplexing means to assure system reliability.

In one application of the present invention, one or more unitized hydraulic systems may be utilized for operation of snowplows, which are traditionally attached to plowing vehicles. As is well understood by those skilled in the art, several hydraulic systems may be utilized to move and position a snowplow blade during operations. These movements include lifting, lowering, angling, and applications providing splits in the blade itself. As will be appreciated from the above discussion regarding the unitized hydraulic system, multiple systems could be coupled to a single snowplow blade to provide appropriate movement and actuation of the blade. Utilizing a number of unitized hydraulic systems provides several advantages, most significantly the interchangeability of hydraulic systems. Utilizing unitized hydraulic systems in applications such as plowing vehicles provides significant advantages including, but not limited to, greatly easing repair costs and allowing operators to make on-the-fly repairs while in the middle of plowing jobs.

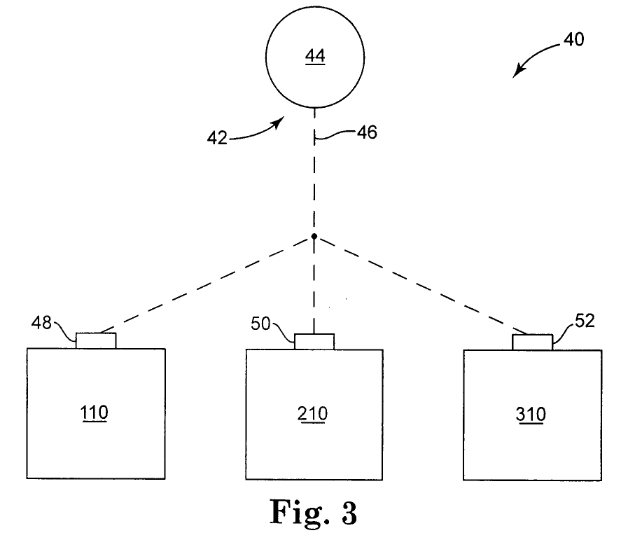

FIGS. 4A and 4B illustrate a top view of a simplified snowplow system 60. In particular, and as illustrated in FIG. 4A, snowplow system 60 includes frame 64, snowplow blade 66 having first blade portion 68, second blade portion 70, and hinge means 72, and a pair of unitized hydraulic systems 10A and 10B attached to frame 64. End portion 38A of shaft 24A is coupled to first blade portion 68, while end portion 38B of shaft 24B is coupled to second blade portion 70. It should be understood that snowplow system 60 is merely one example of a snowplow system, which has been simplified to illustrate how one or more unitized hydraulic systems according to the present invention may be used in such a system.

Snowplow blade 66 of snowplow system 60 is movable between a straight configuration, as shown in FIG. 4A, and a V-shaped configuration, as shown in FIG. 4B. In the straight configuration shown in FIG. 4A, shafts 24A and 24B of unitized hydraulic systems 10A and 10B are both in the extended position. As a result, a substantially straight plow blade is formed.

FIG. 4B is a diagram illustrating snowplow blade 66 in the V-shaped configuration. In the V-shaped configuration, shafts 24A and 24B of unitized hydraulic systems 10A and 10B are both in the retracted position. When shafts 24A and 24B are actuated from the extended to retracted position, first blade portion 68 and second blade portion 70 pivot about hinge means 72 as indicated by angles A and B, respectively. In general, angles A and B are substantially equivalent, although the position of shafts 24A and 24B may be controlled such that angles A and B are not substantially equivalent without departing from the intended scope of the present invention.

It is further contemplated that snowplow system 60 may include a plow headlight, which could house an “on/off” plow coupling switch. In addition, snowplow system 60 may also incorporate and utilize a solid state security system, along with multiplexing, to activate plow coupling.

It should be understood that a snowplow system incorporating unitized hydraulic systems is discussed merely for purposes for example and not limitation. Furthermore, one skilled in the art would appreciate that one or more unitized hydraulic systems according to the present invention may be incorporated into many other types of equipment or systems, including but not limited to construction equipment, earth moving equipment, and lawn care equipment.

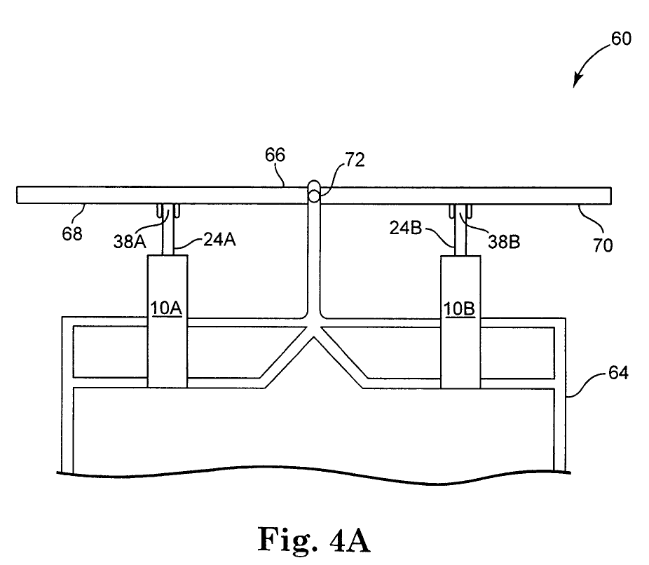

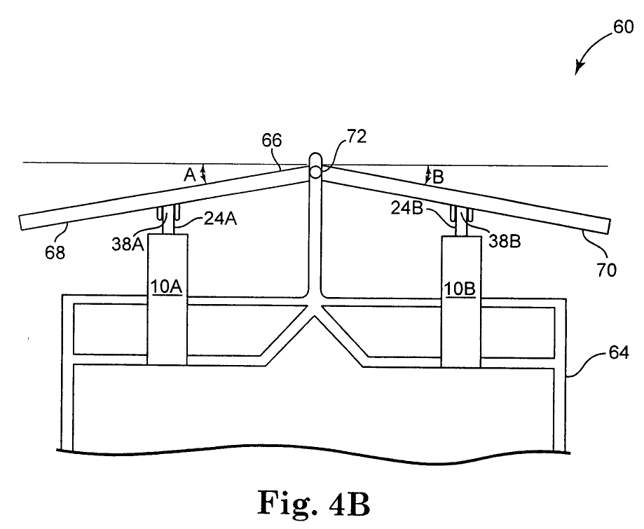

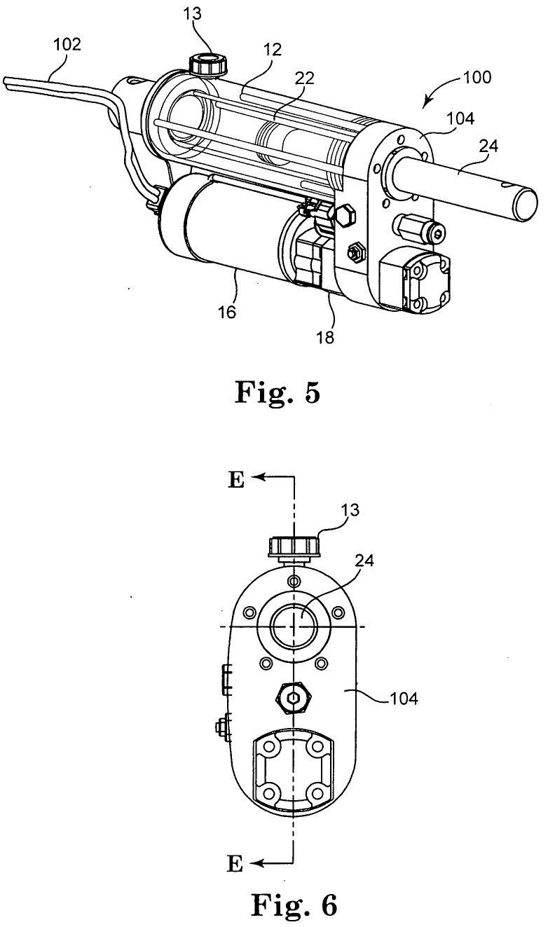

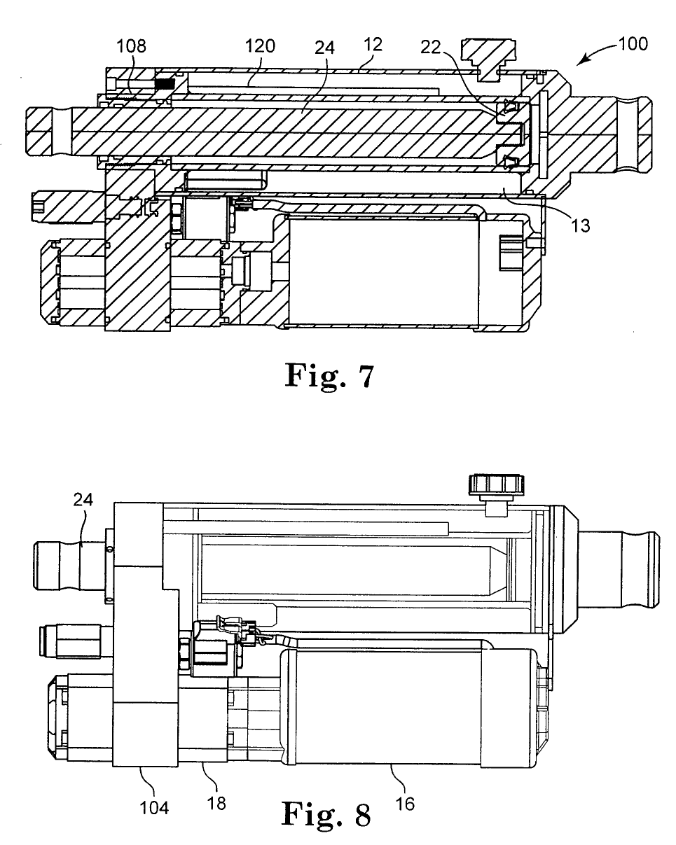

To provide further perspective regarding the unitized hydraulic system of the present invention, FIGS. 5-8 illustrate an alternative embodiment of the present invention. As can be seen, unitized hydraulic system 100 has a slighty modified configuration. For example, a set of electrical connecting wires 102 are shown attached to an opposite side of motor 16. Further, a different housing 104 is utilized to connect many components. Again, FIGS. 5 & 8 are shown to be somewhat transparent to illustrate some of the internal components. Most illustrative however is FIG. 7 which shows a cross sectional diagram along sections lines E-E (as labeled on FIG. 6). FIG. 7 more clearly shows one embodiment of the invention using an integrated tank 12 surrounding the hydraulic cylinder. The interior 13 of tank 12 can also be more completely shown. Additionally, one exemplary internal fluid passageway 120 can be seen in this cross sectional view.

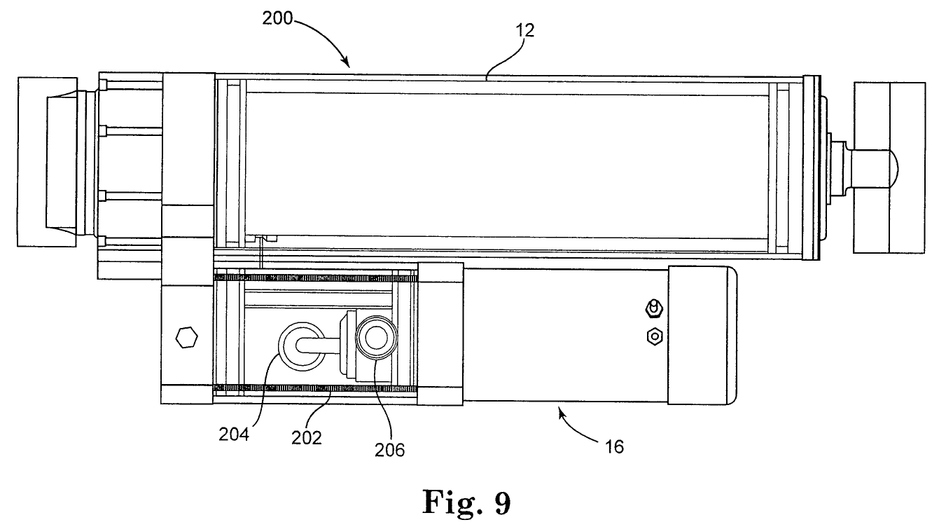

Lastly, FIG. 9 illustrates one additional embodiment of the present invention. Here, a third embodiment of a unitized hydraulic system 200 is shown, which incorporates an additional auxiliary fluid tank 202. In this case, the same type of fluid tank 12 is utilized to surround the hydraulic cylinder (not shown). Again, the same type of motor 16 is utilized. In order to accommodate additional fluid however, auxiliary tank 202 is configured to surround a revised pump 204. Auxiliary tank 202 is in fluid communication with tank 12 to provide additional fluid capacity. A fluid fill cap 206 allows for fluid to be filled into the auxiliary tank 202.

As will be appreciated by one skilled in the art, the unitized hydraulic system of the present invention is very versatile and efficient. Obviously, only a few alternative embodiments of this invention have been illustrated in the drawings and discussed in detail. Naturally, numerous variations could be made to the configuration and arrangement of components within the hydraulic systems while continuing to utilize the overall concept described above.

Although the present invention has been described with reference to preferred embodiments, workers skilled in the art will recognize that changes may be made in form and detail without departing from the spirit and scope of the invention.

What is claimed is:

1. A unitized hydraulic system comprising:
a tank for holding hydraulic fluid;
a hydraulic pump for receiving hydraulic fluid from the tank and creating a high pressure stream of fluid, the hydraulic pump being powered by a pump motor;
a control valve for receiving hydraulic fluid from the hydraulic pump and regulating movement of the hydraulic fluid within the system;
a hydraulic actuator for receiving hydraulic fluid from the control valve to drive a shaft coupled to the actuator; and
a controller in communication with the pump motor and configured to provide controlled actuation of the pump motor, wherein the tank, the hydraulic pump, the control valve, the hydraulic actuator and the controller are all physically coupled to one another forming a unitized component for use as a single hydraulic component.

2. The unitized hydraulic system of claim 1, wherein the pump motor is a switch reluctance motor.

3. The unitized hydraulic system of claim 1, wherein the actuator comprises a hydraulic cylinder having a piston movable between a first position and a second position within the hydraulic cylinder.

4. The unitized hydraulic system of claim 3, wherein the shaft is coupled to and moves in concert with the piston.

5. The unitized hydraulic system of claim 1, wherein the system forms part of a snowplow system and is configured to control movement of a snowplow blade.

6. The unitized hydraulic system of claim 1, and further comprising a housing, wherein the tank, hydraulic pump, control valve, hydraulic actuator, and controller are contained within the housing.

7. The unitized hydraulic system of claim 1, wherein the controller is also in communication with the control valve to regulate operation of the control valve.

8. A unitized hydraulic system comprising:
a tank for holding hydraulic fluid;
a hydraulic pump for receiving hydraulic fluid from the tank, the hydraulic pump being powered by a pump motor;
a hydraulic cylinder for receiving hydraulic fluid from the hydraulic pump to drive a shaft coupled to a piston disposed within the hydraulic cylinder; and
a controller in communication with the hydraulic pump and configured to provide controlled actuation of the pump motor, wherein the tank, the hydraulic pump, the control valve, the hydraulic actuator and the controller are all physically coupled to one another forming a unitized component for use in a application of the hydraulic system.

9. The unitized hydraulic system of claim 8, wherein the pump motor is a switch reluctance motor.

10. The unitized hydraulic system of claim 9, wherein the switch reluctance motor receives a pulse width modulated signal.

11. The unitized hydraulic system of claim 8, and further comprising a speed sensor in communication with the controller for controlling a speed of the piston.

12. The unitized hydraulic system of claim 8, and further comprising a position sensor in communication with the controller for controlling a position of the piston.

13. The unitized hydraulic system of claim 8, wherein the controller includes a predetermined set of parameters for controlling movement of the piston.

14. The unitized hydraulic system of claim 8 wherein the hydraulic cylinder includes a first hydraulic fluid port and a second hydraulic fluid port, wherein the receipt of hydraulic fluid at the first hydraulic fluid port causes the shaft to move in a first direction, while the receipt of hydraulic fluid at the second port causes the shaft to move in a second direction.

15. The unitized hydraulic system of claim 14 wherein the first direction and the second direction are linearly aligned and in opposite directions.

16. A hydraulic system comprising:
a plurality of unitized hydraulic systems, wherein each unitized hydraulic system is a single self-contained system and comprises:
a tank for holding hydraulic fluid;
a hydraulic pump for receiving hydraulic fluid from the tank and creating a high pressure stream of fluid, the hydraulic pump being powered by a pump motor; and
an actuator for receiving hydraulic fluid from the hydraulic pump to drive a shaft coupled to the actuator; and
multiplexing means for providing coordinated control of the unitized hydraulic systems.

17. The hydraulic system of claim 16, wherein the multiplexing means comprises a signal input device for providing a multiplexed signal to the unitized hydraulic systems.

18. The hydraulic system of claim 17, wherein the multiplexing means further comprises a multiplexed node at each unitized hydraulic system for receiving the multiplexed signal from the signal input device.

19. The hydraulic system of claim 16, wherein the unitized hydraulic systems further comprise a control valve disposed between the hydraulic pump and the actuator for regulating movement of hydraulic fluid within the system.

20. The hydraulic system of claim 16 wherein the plurality of unitized hydraulic systems are each configured to operate in both a horizontal and a vertical orientation.
